(19) United States
(12) Patent Application Publication
(10) Pub. No.: US 2014/0344726 A1
(43) Pub. Date: Nov. 20, 2014

(54) INFORMATION PROCESSING METHOD OF IM APPLICATION DEVICE AND SYSTEM, IM APPLICATION DEVICE, TERMINAL, AND STORAGE MEDIUM

(71) Applicant: Tencent Technology (Shenzhen) Company Limited, Guangdong (CN)

(72) Inventors: Jing HE, Guangdong (CN); Xiaomu Wen, Guangdong (CN); Yu Chen, Guangdong (CN); Bin Li, Guangdong (CN)

(21) Appl. No.: 14/309,465

(22) Filed: Jun. 19, 2014

Related U.S. Application Data
(63) Continuation of application No. PCT/CN2013/089996, filed on Dec. 19, 2013.

(30) Foreign Application Priority Data
May 14, 2013 (CN) 201310176325.0

(51) Int. Cl. H04L 12/58; G06F 3/0481

(52) U.S. Cl. CPC H04L 51/046; G06F 3/04817
USPC 715/758

(57) ABSTRACT

The invention discloses an information processing method of IM application device and system, an IM application device, a terminal, and a storage medium, which all belong to the computer technologies. The method comprises: an IM application device at the sending terminal acquires text information to be sent; sends the text information to the receiving terminal; and displays an animation corresponding to the text information in a chat window of the sending terminal. The IM application device at the receiving terminal receives text information sent by a sending terminal; acquiring an icon of an animation corresponding to the text information taken as a keyword sentence according to a correspondence relationship between the icon of the animation and the keyword sentence; and displays the text information and the animation corresponding to the text information in a chat window of the receiving terminal. In the technical solution of the present invention, the text information can be transferred between the IM application devices at the sending terminal and the receiving terminal, and the animation corresponding to the text information can be displayed at the same time, when a user on the receiving side is unfamiliar with the meaning expressed by the image information or the displayed image can't be seen clearly due to the small region displaying the image, the meaning expressed by the image can still be acquired correctly, which leads to the improved efficiency of transferring image information between IM applications.

### CROSS-REFERENCE TO RELATED APPLICATION

This application claims priority to and is a continuation of PCT/CN2013/089996, filed on Dec. 19, 2013 and entitled “Information Processing Method of IM Application Device And System, IM Application Device, Terminal, and Storage Medium”, which claims the benefit of Chinese Patent Application No. 201310176325.0, filed with the Chinese Patent Office on May 14, 2013 and titled “Information Processing Method and System, IM Application Device And Terminal”, the contents of which are incorporated herein by reference in their entirety.

### FIELD OF THE INVENTION

The present invention relates to the field of computer technologies, and in particular to an information processing method of IM application device and system, an IM application device, a terminal, and a storage medium.

### BACKGROUND OF THE INVENTION

The information transmission becomes increasingly frequent along with the rapid development of science and technology, for example, mutual information transmission may be conducted through the Internet between Instant Messenger (IM) applications installed in terminals, such as short message service applications, QQ, and Fetion installed in mobile phones.

As for the IM information transmission in the prior art, voice information, image information and text information may be transferred between the IM applications, and the text information is mostly transferred, that is, the text information is input to an IM application on the sending side and sent to an IM application on the receiving side. The transfer of voice information between IM applications is getting more and more frequent along with the development of the information transmission technologies in recent years. For example, a user of the IM application on the sending side speaks with a microphone, and the audio information from the user can be stored and sent by the IM supplication on the sending side to the IM application on the receiving side. The transfer of the image information between IM applications is mostly used to transfer facial images corresponding to key words or sentences in the transferred texts, thus the IM applications on both the sending side and the receiving side are required to support the transfer of such facial images, to ensure the correct transfer and display of the facial images.

In conducting the present invention, at least the following problems in the prior art are found by inventor.

In the prior art, when image information is transferred between the IM applications, the display of the image is limited to a small region in a chat window of the IM application, and the texts corresponding to the image information are not transferred at the time of transferring the image information. In this case, if the user on the receiving side is unfamiliar with the meanings expressed by the image or the image cannot be clearly seen due to the small region displaying the image, the meanings expressed by the image could not be acquired correctly by the user, which leads to a low efficiency of transferring the image information between IM applications.

### SUMMARY OF THE INVENTION

The purpose of embodiments of the present invention is to provide an information processing method of IM application device and system, an IM application device, a terminal, and a storage medium to optimize the information transmission between IM applications.

In one aspect, an embodiment of the present invention provides an information processing method of IM application device, including:

acquiring text information to be sent;

sending the text information to a receiving terminal; and

displaying an animation corresponding to the text information in a chat window of a sending terminal of the IM application device, wherein a correspondence relationship between an icon of the animation and a keyword sentence taken as the text information is locally stored in the sending terminal of the IM application device.

Optionally, “Acquiring text information to be sent” in the method provided in above one aspect comprises: receiving the text information inputted through a man-machine interface module by a user.

Optionally, after acquiring text information to be sent and before sending the text information to a receiving terminal, the method further comprises:

acquiring an icon of the animation corresponding to the text information taken as a keyword sentence according to the correspondence relationship between the icon of the animation and the keyword sentence;

further, displaying an animation corresponding to the text information comprises:

displaying the animation corresponding to the icon of the animation corresponding to the text information.

Optionally, “acquiring text information to be sent” in the method provided in above one aspect comprises:

receiving the icon of the animation selected through a man-machine interface module by a user;

acquiring a keyword sentence corresponding to the icon of the animation according to the correspondence relationship between the icon of the animation and the keyword sentence; and

taking the keyword sentence acquired as the text information to be sent.

Optionally, “displaying an animation corresponding to the text information” in the method provided in above one aspect comprises: displaying the animation corresponding to the text information in full screen in the chat window.

In another aspect, a processing information method of IM application is also provided, the method comprises:

receiving text information sent by a sending terminal;

acquiring an icon of an animation corresponding to the text information taken as a keyword sentence according to a correspondence relationship between the icon of the animation and the keyword sentence, wherein the correspondence relationship between the icon of the animation and the keyword sentence taken as the text information is locally stored in the receiving terminal of the IM application device; and

displaying the text information and an animation corresponding to the icon of the animation corresponding to the text information in a chat window of a receiving terminal of the IM application device at the same time.

Optionally, “displaying an animation corresponding to the text information” in the method provided in above another aspect comprises: displaying the animation corresponding to the text information in full screen in the chat window.

In the other aspect, an IM application device is provided, where the IM application device is a sending terminal in a communication system, it comprises:

a first acquiring module which is used to acquire text information to be sent;

a sending module which is used to send the text information to a receiving terminal; and

a first display module which is used to display an animation corresponding to the text information in a chat window of a sending terminal of the IM application device, wherein a correspondence relationship between an icon of the animation and a keyword sentence taken as the text information is locally stored in the sending terminal of the IM application device.

Optionally, the first acquiring module in the IM application device provided in above other aspect is particularly used to receive the text information inputted through a man-machine interface module by a user.

Optionally, the first acquiring module in the IM application device provided by above other aspect is particularly used to acquire an icon of the animation corresponding to the text information taken as a keyword sentence, after acquiring the text information to be sent, before the first display module displays an animation corresponding to the text information.

The first display module is particularly used to display the animation corresponding to the icon of the animation corresponding to the icon of the animation corresponding to the text information.

Optionally, the first acquiring module in the IM application device provided in above other aspect is particularly used to receive the icon of the animation selected by a user through a man-machine interface module; acquire a keyword sentence corresponding to the icon of the animation according to the correspondence relationship between the icon of the animation and the keyword sentence; and take the acquired keyword sentence as the text information to be sent.

Optionally, the first display module in the IM application device provided in above other aspect is particularly used to display the animation corresponding to the text information in full screen in a chat window.

In still another aspect, an IM application device is also provided, which is a receiving terminal in a communication system, comprises:

a receiving module which is used to receive text information sent by a sending terminal;

a second acquiring module which is used to acquire an icon of an animation corresponding to the text information taken as a keyword sentence according to a correspondence relationship between the icon of the animation and the keyword sentence, wherein the correspondence relationship between the icon of the animation and the keyword sentence taken as the text information is locally stored in the receiving terminal of the IM application device; and

a second display module which is used to display the text information and an animation corresponding to the icon of the animation corresponding to the text information in a chat window of a receiving terminal of the IM application device at the same time.

Optionally, the second display module in the IM application device provided in above still another aspect is particularly used to display the animation corresponding to the text information in full screen in the chat window.

In still other aspect, a communication system is provided, and it comprises an IM application device at the sending side and an IM application device at the receiving side which are in communication with each other; and the IM application device at the sending side can be any one of the IM application devices provided in above other aspect; the IM application device at the receiving side can be any one of the IM application devices provided in above still another aspect.

In yet still another aspect, a terminal is provided, and there is any one of the IM application devices provided in above other aspect, and/or any one of the IM application devices provided in above yet still another aspect set in the terminal.

The advantages brought about by the technical solutions provided by the embodiments of the present invention are as follows.

In yet still another aspect, a storage medium is provided, which includes computer-executable instructions which, when executed by the computer processor, are configured to perform an information processing method of IM application device, and the method comprises:

acquiring text information to be sent;

sending the text information to a receiving terminal; and

displaying an animation corresponding to the text information in a chat window of a sending terminal of the IM application device, wherein a correspondence relationship between an icon of the animation and a keyword sentence taken as the text information is locally stored in the sending terminal of the IM application device.

In yet still another aspect, a storage medium is provided, which includes computer-executable instructions which, when executed by the computer processor, are configured to perform an information processing method of IM application device, and the method comprises:

receiving text information sent by a sending terminal;

acquiring an icon of an animation corresponding to the text information taken as a keyword sentence according to a correspondence relationship between the icon of the animation and the keyword sentence, wherein the correspondence relationship between the icon of the animation and the keyword sentence taken as the text information is locally stored in the receiving terminal of the IM application device; and

displaying the text information and an animation corresponding to the icon of the animation corresponding to the text information in a chat window of a receiving terminal of the IM application device at the same time.

With the present invention, the text information for sending is acquired and sent by the sending terminal to the receiving terminal, and the animation corresponding to the text information is displayed; the receiving terminal receives the text information sent by the sending terminal, and displays both the text information and the animation corresponding to the text information. In the technical solution of the present embodiment, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

### BRIEF DESCRIPTION OF THE DRAWINGS

Now the accompanying drawings needed for the description of the present embodiment will be described in brief below for clearly describing the technical solutions of the present embodiment. Apparently, the accompanying drawings in the description below illustrate only partial embodiments of the present invention, and other figures can be acquired in light of the described figures without creative work by the skilled person in the art.

FIG. 1 is a flow chart of the information processing method of IM application device provided in a first embodiment of the present invention.

FIG. 2 is a flow chart of the information processing method of IM application device provided in a second embodiment of the present invention.

FIG. 3 is a flow chart of the information processing method of IM application device provided in a third embodiment of the present invention.

FIG. 4 is a signaling diagram of the information processing method of IM application device provided in a fourth embodiment of the present invention.

FIG. 5 is a schematic view showing a quickly sending interface applied to the fourth embodiment of the present invention.

FIG. 6 is a state diagram 1 of the chat window animation applied to the embodiment of the present invention.

FIG. 7 is a state diagram 2 of the chat window animation applied to the embodiment of the present invention.

FIG. 8 is a state diagram 3 of the chat window animation applied to the embodiment of the present invention.

FIG. 9 is a state diagram 4 of the chat window animation applied to the embodiment of the present invention.

FIG. 10 is a schematic view showing the structure of the IM application device provided in a fifth embodiment of the present invention.

FIG. 11 is a schematic view showing the structure of the IM application device provided in a sixth embodiment of the present invention.

### DETAILED DESCRIPTION OF THE EMBODIMENTS

Now the embodiments of the present invention will be described in further detail below in combination with the accompanying drawings for making the purpose, technical solutions and advantages of the present invention clearer. Apparently, the described embodiments are only a part of not all of the embodiments of the present invention, and are used for describing the principle of the present invention, without limiting the present invention to these particular embodiments. Other embodiments acquired in light of the described embodiments without creative work by the skilled person in the art fall within the scope of the present invention.

### First Embodiment

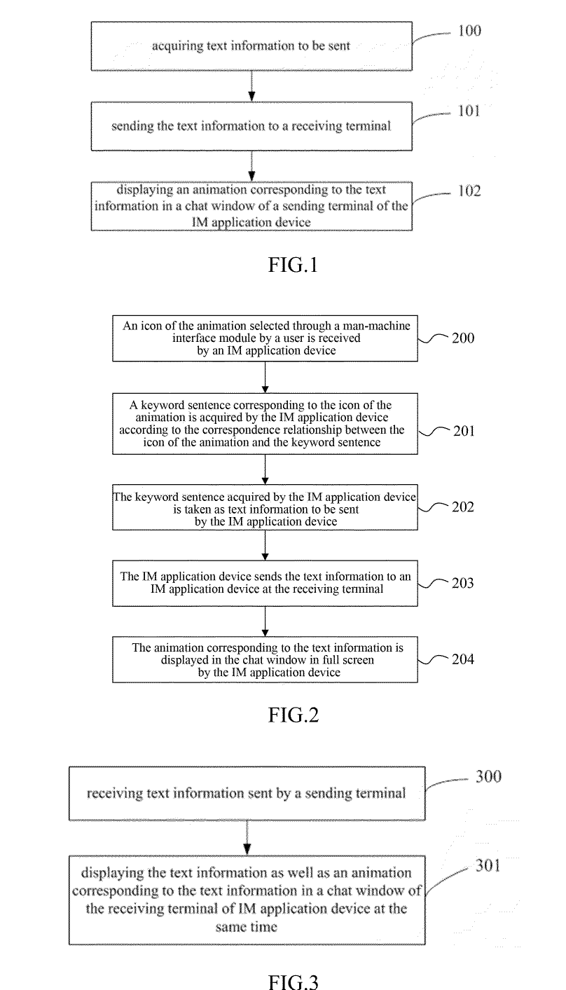

FIG. 1 is a flow chart of the information processing method of IM application device provided in the first embodiment of the present invention. As illustrated in FIG. 1, the information processing method of IM application device in the present embodiment may particularly include following steps of:

100: acquiring text information to be sent;

101: sending the text information to a receiving terminal; and

102: displaying an animation corresponding to the text information in a chat window of a sending terminal of the IM application device, wherein a correspondence relationship between an icon of the animation and a keyword sentence taken as the text information is locally stored in the sending terminal of the IM application device.

The information processing method in the present embodiment can be particularly performed by the IM application device which may particularly be an application client (such as an application client with integrated software) arranged at a terminal. The technical solution of the present embodiment at the side of the sending terminal is mainly described in detail in the present embodiment.

In the information processing method in the present embodiment, the text information is acquired and sent to the receiving terminal, and the animation corresponding to the text information is also displayed, so that the text information sent by the sending terminal is received and displayed by the receiving terminal, meanwhile the animation corresponding to the text information is displayed. Moreover, the sending terminal can display the animation corresponding to the text information when sending the text information. In the technical solution of the present embodiment, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

Further optionally, at the basis of the technical solution in the above embodiment, the step 100 of acquiring text information to be sent particularly is described in the following two cases:

In case 1, the step 100 of acquiring text information to be sent may particularly include receiving text information inputted through a man-machine interface module by a user.

For example, text information to be sent that is inputted through a touch screen or a keyboard by the user is received.

Accordingly, after the step 100 of acquiring text information to be sent and before the step 102 of displaying an animation corresponding to the text information, the method also includes: acquiring an icon of the animation corresponding to the text information taken as a keyword sentence according to the correspondence relationship between the icon of the animation and the keyword sentence, before or after the step 101.

Further accordingly, the step 102 of displaying an animations corresponding to the text information may particularly include: displaying the animation corresponding to the icon.

In case 2, the step 100 of acquiring text information to be sent may particularly include the following steps of:
(1) receiving an icon of an animation selected through a man-machine interface module by a user;
(2) acquiring a keyword sentence corresponding to the icon of the animation according to the correspondence relationship between the icon of the animation and the keyword sentence; and
(3) taking the acquired keyword sentence as the text information to be sent.

In this case, the correspondence relationship between the icon of the animation and the keyword sentence is preset in the IM application devices. Such keyword sentence is stored in the format of text information. For example, a quickly sending page may be arranged, and shown in full screen when a user opens a chat window and slides the screen by a finger. Each icon of the animation corresponds to a keyword sentence. For example, when the user clicks on a birthday day icon, the corresponding keyword sentence is “Happy Birthday”. When the icon of the animation is clicked, the corresponding keyword sentence is generated and sent to the receiving terminal. The icon of each animation is linked to the animation corresponding to the text information.

It shall be further noted that, at the basis of the technical solution of above embodiment, the step 102 of displaying an animation corresponding to the text information may particularly include: displaying the animation corresponding to the text information in full screen within the chat window, which further enriches the functions of the IM application, so that the IM applications can be used more flexibly.

All of the alternative solutions of the above embodiments can be combined in any manner to form an alternative embodiment of the present invention, which would not be repeated.

With the above information processing method, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

Moreover, in the technical solution of the present embodiment, the displayed animation is not limited to the animation selected by the user. When the user inputs only text information, the IM application device may automatically provide an animation matching with the text information. The stored correspondence relationship between a text and an animation in the IM application device on the sending side may be the same as or different from the stored correspondence relationship between a text and an animation in the IM application device on the receiving side. The IM application device may display the animation for the local text information to be sent or the received text information, based on the local stored correspondence relationship between the text and the animation. Such technical solution allows the user to customize the animations. Or, the correspondence relationships between the icons of animations and keyword sentences, which are adopted by the IM application devices, can be updated and enriched by a cloud server.

### Second Embodiment

FIG. 2 is a flow chart of the information processing method of IM application device provided in the second embodiment of the present invention. The information processing method in the present embodiment is further introduced below in connection with FIG. 2 in addition to the embodiment shown in FIG. 1 and the above optional embodiment. As illustrated in FIG. 2, the information processing method in the present embodiment particularly includes following steps that:

200: an icon of the animation selected through a man-machine interface module by a user is received by an IM application device;

201: a keyword sentence corresponding to the icon of the animation is acquired by the IM application device according to the correspondence relationship between the icon of the animation and the keyword sentence;

202: the keyword sentence acquired by the IM application device is considered as text information to be sent by the IM application device;

203: the IM application device sends the text information to an IM application device at the receiving terminal;

where in the step 203, the IM application device in the receiving side can receive the text information; meanwhile, the IM application device at the receiving terminal can acquire the animation corresponding to the text information taken as the keyword sentence according to the correspondence relationship between the icon of the animation and the keyword sentence, and the animation may be displayed in a chat window in full screen; and

204: the animation corresponding to the text information is displayed in the chat window in full screen by the IM application device.

With the above information processing method, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

### Third Embodiment

FIG. 3 is a flow chart of the information processing method of IM application device provided in the third embodiment of the present invention. As illustrated in FIG. 3, the information processing method in the present embodiment can particularly include following steps of:

300: receiving text information sent by a sending terminal; and

301: displaying the text information as well as an animation corresponding to the text information in a chat window of the receiving terminal of IM application device at the same time.

The information processing method in the present embodiment can particularly be performed by an IM application device which may be an application client (such as an application client with integrated software) arranged in a terminal. The difference between the present embodiment and the embodiment illustrated in FIG. 1 is that the technical solution of the present invention is described at the side of the sending terminal in the embodiment illustrated in FIG. 1, but the technical solution of the present embodiment is described at the side of a receiving terminal in the present embodiment.

In the information processing method in the present embodiment, the IM application device at the receiving terminal receives and displays the text information sent by the sending terminal, and further displays the animation corresponding to the text information at the same time. With the technical solution of the present invention, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

Further optionally, at the basis of the technical solution in the embodiment illustrated in FIG. 3, after the step 300 of receiving text information sent by a sending terminal and before the step 301 of displaying an animation corresponding to the text information, the method also includes: acquiring the icon of the animation corresponding to the text information taken as a keyword sentence according to the correspondence relationship between the icon of the animation and the keyword sentence. Optionally, the correspondence relationship between the icon of the animation and the keyword sentence taken as the text information is locally stored in the receiving terminal of the IM application device.

That is, the correspondence relationship between the icon of the animation and the keyword sentence can be prestored at the side of the receiving terminal. When text information is received, an icon of an animation corresponding to the text information can be acquired at the receiving terminal according to the correspondence relationship between the icon of the animation and the keyword sentence to enable the display of the animation linked to the icon.

Further optionally, displaying an animation corresponding to the text information in the step 301 can particularly include: displaying the animation corresponding to the icon of the animation corresponding to the text information.

Further optionally, displaying an animation corresponding to the text information in the step 301 can particularly include: displaying the animation corresponding to the text information in a chat window in full screen.

In the information processing method in the present embodiment, the IM application device at the receiving terminal receives and displays the text information sent by the sending terminal, and further displays the animation corresponding to the text information at the same time. With the technical solution of the present invention, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

### Fourth Embodiment

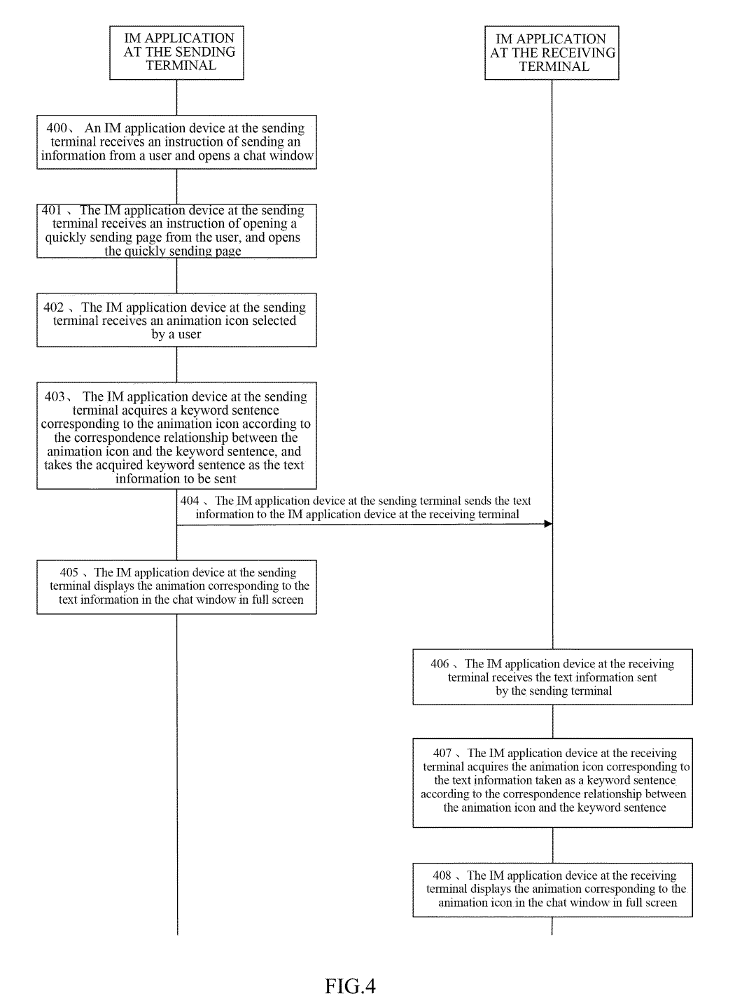

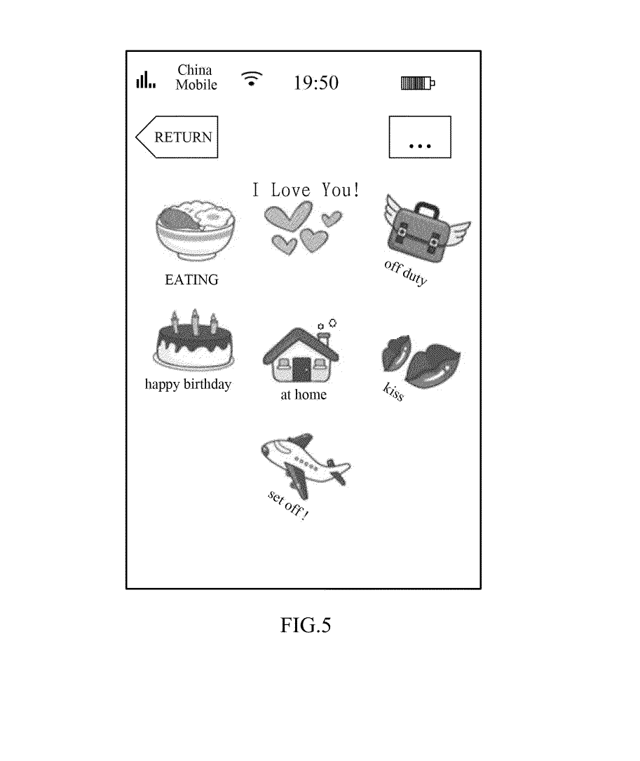

FIG. 4 is a signaling diagram of the information processing method of IM application device provided in the fourth embodiment of the present invention. As illustrated in FIG. 4, the present embodiment will further describe the technical solution in more detail at the basis of all the above embodiments. As illustrated in FIG. 4, the information processing method in the present embodiment particularly includes following steps 400-408.

400: An IM application device at the sending terminal receives an instruction of sending information from a user and opens a chat window.

401: The IM application device at the sending terminal receives an instruction of opening a quickly sending page from the user, and opens the quickly sending page.

Herein, several animation icons may be included in the quickly sending page, and each animation icon is linked to an animation and also corresponds to a keyword sentence which may be stored in the format of the text information. FIG. 5 is a schematic view showing a quickly sending interface applied to the fourth embodiment of the present invention. As illustrated in FIG. 5, for example, there are five animation icons in the present embodiment, each of the animation icons corresponds to an animation, and texts around each animation icon represent the keyword sentence corresponding to the animation icon.

402: The IM application device at the sending terminal receives an animation icon selected by a user.

403. The IM application device at the sending terminal acquires a keyword sentence corresponding to the animation icon according to the correspondence relationship between the animation icon and the keyword sentence, and takes the acquired keyword sentence as the text information to be sent.

404: The IM application device at the sending terminal sends the text information to the IM application device at the receiving terminal.

405: The IM application device at the sending terminal displays the animation corresponding to the text information in the chat window in full screen.

406: The IM application device at the receiving terminal receives the text information sent by the sending terminal.

407: The IM application device at the receiving terminal acquires the animation corresponding to the text information taken as a keyword sentence according to the correspondence relationship between the animation icon and the keyword sentence.

408: The IM application device at the receiving terminal displays the animation corresponding to the animation icon in the chat window in full screen.

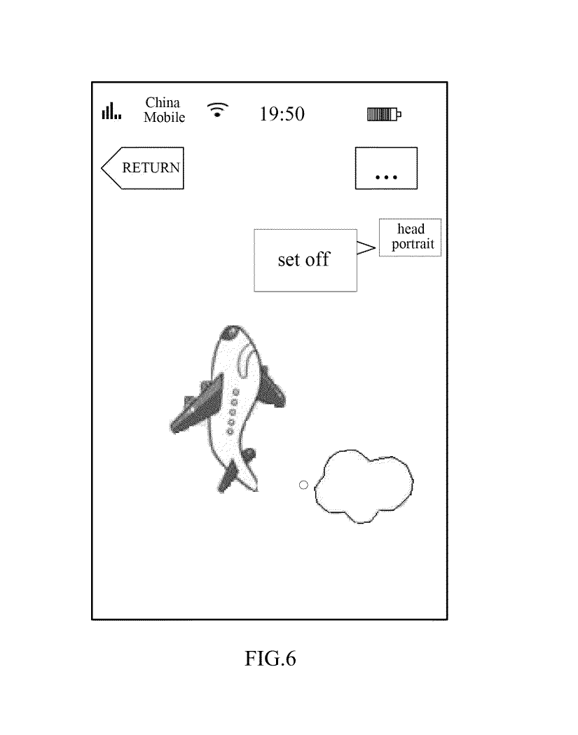

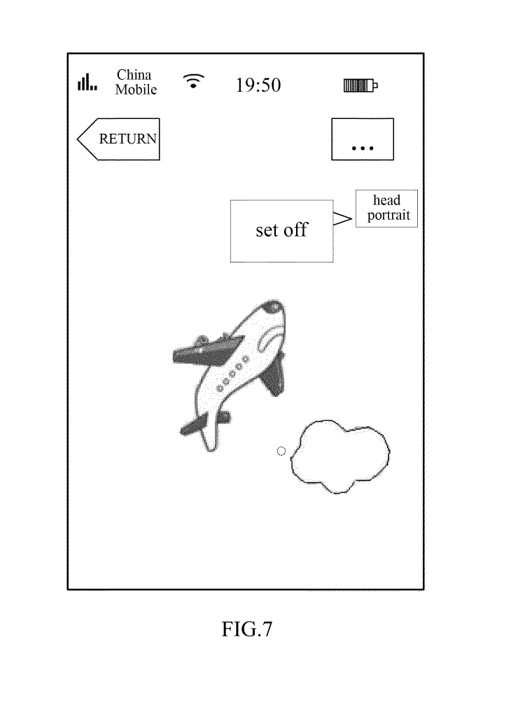

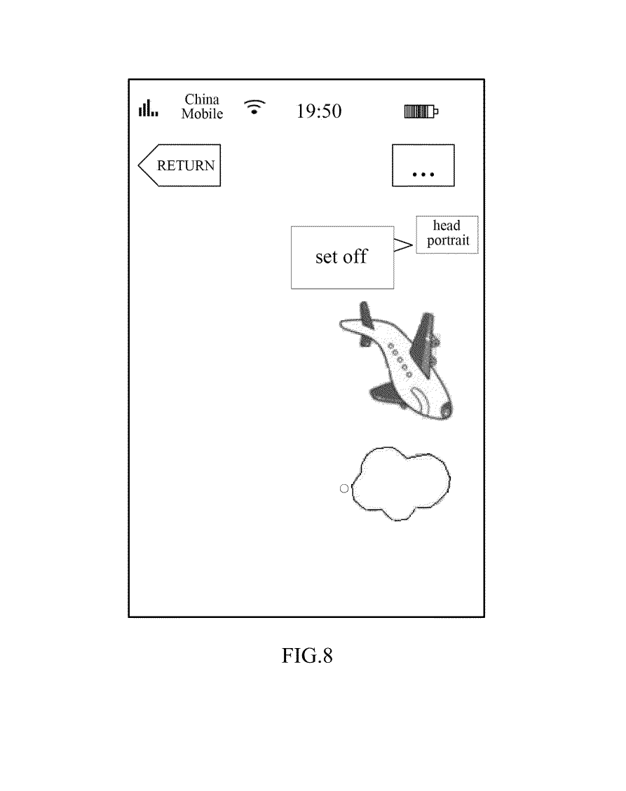

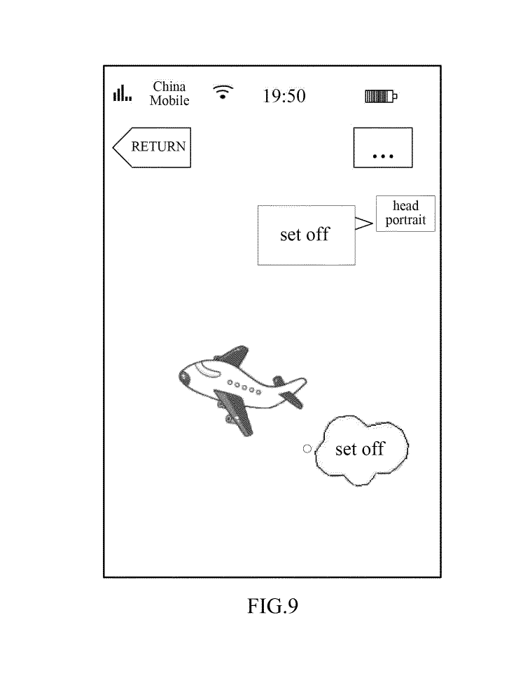

For example, in the above technical solution in the present embodiment, when the IM application device at the sending terminal sends the text information of “set off” to the IM application device at the receiving terminal, a continuous animation illustrated in FIGS. 6 to 9 may be displayed in both the chat window of the IM application device at the sending terminal and that of the IM application device at the receiving terminal. Here, each of FIGS. 6 to 9 shows a picture of the continuous animation, and all the pictures in FIGS. 6-9 jointly form the animation.

With the information processing method of the present embodiment, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

### Fifth Embodiment

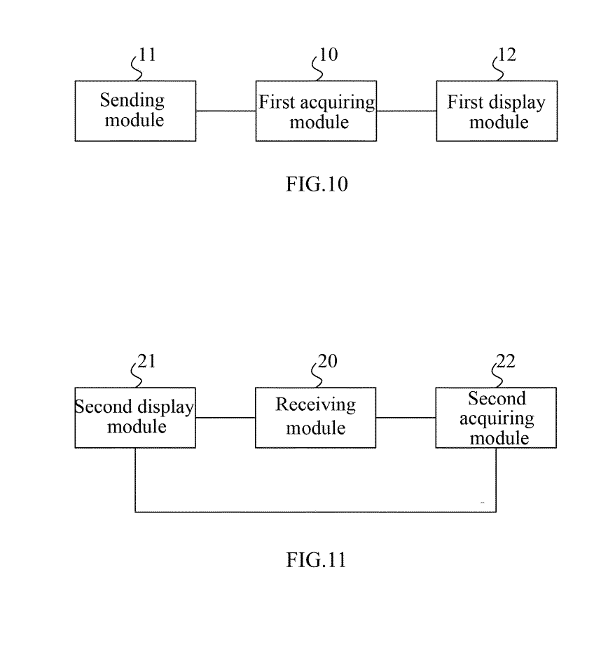

FIG. 10 is a schematic view showing the structure of the IM application device provided in the fifth embodiment of the present invention. The IM application device in the present embodiment is a sending terminal in a communication system, and includes a first acquiring module 10, a sending module 11 and a first display module 12.

The first acquiring module 10 is used for acquiring text information to be sent; the sending module 11 is connected with the first acquiring module 10 and used for sending the text information acquired by the first acquiring module 10 to a receiving terminal; and the first display module 12 is connected to the first acquiring module 10 and is used for displaying an animation corresponding to the text information acquired by the first acquiring module 10 in a chat window of a sending terminal of the IM application device, wherein a correspondence relationship between an icon of the animation and a keyword sentence taken as the text information is locally stored in the sending terminal of the IM application device.

The implementation mechanism of information processing based on the above modules, which is performed by the IM application device in the present embodiment, is the same as the implementation mechanism of the method in the above embodiments, and reference may be made to the description of the above related embodiment without further duplicated description herein.

With the above modules of the IM application device of the present embodiment, the text information to be sent is acquired and sent to the receiving terminal, and the animation corresponding to the text information is also displayed. The receiving terminal receives and displays the text information sent by the sending terminal, and further displays the animation corresponding to the text information at the same time. With the technical solution of the present invention, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

Further optionally, the first acquiring module 10 at the basis of the embodiment illustrated in FIG. 5 is particularly used to receive the text information inputted by a user through a man-machine interface.

Further optionally, the first acquiring module 10 based on the above embodiment is also used to acquire the icon of the animation corresponding to the text information taken as a keyword sentence according to the correspondence relationship between the icon of the animation and the keyword sentence, after the sending module sends the text information to the receiving terminal and before the first display module displays an animation corresponding to the text information; and the first display module 12 is particularly used to display the animation corresponding to the icon of the animation corresponding to the text information.

Further optionally, at the basis of the above embodiment, the first acquiring module 10 is particularly used to receive the animation icon selected by a user through a man-machine interface module; acquire a keyword sentence corresponding to the animation icon according to the correspondence relationship between the animation icon and the keyword sentence; and take the keyword sentence as the text information to be sent.

Further optionally, the first display module 12 is particularly used to display the animation corresponding to the text information in a chat window in full screen at the basis of above embodiment.

It is noted that all the optional technical solutions of the above embodiment may be combined in any manner to form an alternative embodiment of the present invention, which will not be repeatedly described here.

The implementation mechanism of information processing based on the above modules, which is performed by the IM application device in the present embodiment, is the same as the implementation mechanism of the method in the above embodiments, and reference may be made to the description of the above related embodiment, without further duplicated description herein.

With the above modules of the IM application device of the above embodiment, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

### Sixth Embodiment

FIG. 11 is a schematic view showing the structure of the IM application device provided in the sixth embodiment of the present invention. As illustrated in FIG. 11, the IM application device in the present embodiment is a receiving terminal in a communication system, and may particularly include a receiving module 20 and a second display module 21.

The receiving module 20 is used to receive the text information sent by the sending terminal; and the second display module 21 is connected to the receiving module 20 and is used to display the text information received by the receiving module 20 and the animation corresponding to the text information.

The implementation mechanism of information processing based on the above modules, which is performed by the IM application device in the present embodiment, is the same as the implementation mechanism of the method in the above embodiments, and reference may be made to the description of the above related embodiments, without further duplicated description herein.

With the above modules of the IM application device of present embodiment, the text information sent by the sending terminal is received and displayed, and the animation corresponding to the text information is displayed at the same time. With the technical solution of the present invention, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

Further optionally, as illustrated in FIG. 6, the IM application device of the above embodiment can also include a second acquiring module 22, which is connected to the receiving module 20 and is used to acquire an icon of the animation corresponding to the text information taken as a keyword sentence according to the correspondence relationship between the icon of the animation and the keyword sentence, after the receiving module 20 receives the text information sent by the sending terminal and before the second display module 21 displays the animation corresponding to the text information; at this time, the second display module 21 is connected to the second acquiring module 22 and is particularly used to display the animation corresponding to the animation icon corresponding to the text information acquired by the second acquiring module 22.

Further optionally, in the IM application device of the above embodiment, the second display module 21 is particularly used to display the animation corresponding to the text information in full screen in the chat window.

The implementation mechanism of information processing based on the above modules, which is performed by the IM application device in the present embodiment, is the same as the implementation mechanism of the method in the above embodiments, and reference may be made to the description of the above related embodiments, which will not be repeatedly described.

With the above modules of the IM application device of the above embodiment, while the text information is transferred between the IM application devices at the sending terminal and the receiving terminal, the animation corresponding to the text information is also displayed at the sending terminal and the receiving terminal, so that if a user on the receiving side is unfamiliar with the meaning expressed by the image information or the displayed image cannot be clearly seen due to the small region displaying the image, the meaning expressed by the image can still be acquired correctly, which leads to the improved efficiency of transferring image information between the IM applications. Furthermore, no matter after the text message is sent by the IM application device at the sending terminal or after the text message is received by the IM application device at the receiving terminal, the animation corresponding to the last sent or received text message is displayed, thereby further enriching the functions of the IM application, so that the IM application can be used more flexibly.

A communication system is also provided by an embodiment of the present invention. The communication system includes an IM application device on the sending side and an IM application device on the receiving side, which are in communication with each other; and the IM application device on the sending side may be the IM application device illustrated in FIG. 10, while the IM application device on the receiving side may be the IM application device illustrated in FIG. 11, and reference may be made to the above related embodiments for details and duplicated description will not be provided herein.

The information processing can be achieved by particularly the information processing method as illustrated in FIGS. 1 to 4, and reference may be made to the above related embodiments for details and repeated description will not be provided herein.

An embodiment of the present invention further provides a terminal, which is provided with an IM application device illustrated in FIG. 10 and/or an IM application device illustrated in FIG. 11. That is, an IM application device on the sending side or an IM application device on the receiving side can be provided in the terminal; or both an IM application device on the sending side and an IM application device on the receiving side can be provided in the terminal. Reference can be made to the description of the above related embodiments for the details of the information processing method, which will not be repeatedly described herein.

It should be noted that when the IM application device provided by the above embodiments is used for processing information, the division of the IM application device into the above various functional modules is described as an example, and the above functions can be distributedly completed by different functional modules as desired in practice, that is, the internal construction of the IM application device can be de divided into different functional modules to conduct all or a part of functions described above. Additionally, the IM application device and the information processing method provided in the above embodiments belong to the same concept, and reference may be made to the methods provided in the above embodiments for detailed implementing of the IM application device and the methods, which will not be repeatedly described herein.

An embodiment of the present invention provides a storage medium including computer-executable instructions which, when executed by a computer processor, is configured to perform an information processing method of IM application device, and the method includes:

acquiring text information to be sent;

sending the text information to a receiving terminal; and

displaying an animation corresponding to the text information in a chat window of a sending terminal of the IM application device, wherein a correspondence relationship between an icon of the animation and a keyword sentence taken as the text information is locally stored in the sending terminal of the IM application device.

The method performed by the executable instructions stored in the above storage medium is suitable for a sending terminal, and particularly, the executable instructions are configured to perform the information processing method at the sending terminal provided by any embodiment of the present invention.

An embodiment of the present invention provides a storage medium including computer-executable instructions which, when executed by a computer processor, is configured to perform an information processing method of IM application device, and the method includes:

receiving text information sent by a sending terminal;

acquiring an icon of an animation corresponding to the text information taken as a keyword sentence according to a correspondence relationship between the icon of the animation and the keyword sentence, wherein the correspondence relationship between the icon of the animation and the keyword sentence taken as the text information is locally stored in the receiving terminal of the IM application device; and

displaying the text information and an animation corresponding to the icon of the animation corresponding to the text information in a chat window of a receiving terminal of the IM application device at the same time.

The method performed by the executable instructions stored in the above storage medium is suitable for a receiving terminal, and particularly, the executable instructions are configured to perform the information processing method at the receiving terminal provided by any embodiment of the present invention.

It should be apparent to the skilled person in the art from the description of the above embodiments that the present invention can be implemented by both software and the required general hardware, or implemented by hardware merely, but the former case is mostly preferable. In view of this understanding, the technical solution of the present invention or the part of the technical solution contributing to the prior art may embodied by a software product, which may be stored in the computer-readable storage medium such as Floppy disk, Read-only Memory (ROM), Random Access Memory (RAM), Flash, Hard disk, Compact Disc and the like, and the software product includes instructions configured to instruct a computer device (which can be a Personal Computer, a server or a network equipment) to perform the methods described in the embodiments of the present invention.

The order of the embodiments of the present invention is merely for illustration, and does not mean the superiorities of the embodiments.

Those skilled in the art can understand that all or a part of the steps in the above embodiments may be performed through hardware, also through instructing relative hardware by a software program which may be stored in a computer-readable storage medium, and the storage medium may be a ROM, a disk or a compact disk.

Preferable embodiments have been described as above, without limiting the present invention. Any modification, equivalent replacement, improvement and the like made without departing from the scope and principle of the present invention fall within the scope of the present invention.

1. An information processing method of IM application device, comprising:
acquiring text information to be sent;
sending the text information to a receiving terminal; and
displaying an animation corresponding to the text information in a chat window of a sending terminal of the IM application device, wherein a correspondence relationship between an icon of the animation and a keyword sentence taken as the text information is locally stored in the sending terminal of the IM application device.

2. The information processing method according to claim 1, wherein, acquiring text information to be sent comprises receiving the text information inputted through a man-machine interface module by a user.

3. The information processing method according to claim 2, wherein, after acquiring text information to be sent and before sending the text information to a receiving terminal, the method further comprises:
acquiring an icon of the animation corresponding to the text information taken as a keyword sentence according to the correspondence relationship between the icon of the animation and the keyword sentence;
wherein displaying an animation corresponding to the text information comprises:
displaying the animation corresponding to the icon of the animation corresponding to the text information.

4. The information processing method according to claim 1, wherein, acquiring text information to be sent comprises:
receiving the icon of the animation selected through a man-machine interface module by a user;
acquiring a keyword sentence corresponding to the icon of the animation according to the correspondence relationship between the icon of the animation and the keyword sentence; and
taking the acquired keyword sentence as the text information to be sent.

5. The information processing method according to claim 1, wherein, displaying an animation corresponding to the text information comprises: displaying the animation corresponding to the text information in full screen in the chat window.

6. An information processing method of IM application device, comprising:
receiving text information sent by a sending terminal;
acquiring an icon of an animation corresponding to the text information taken as a keyword sentence according to a correspondence relationship between the icon of the animation and the keyword sentence, wherein the correspondence relationship between the icon of the animation and the keyword sentence taken as the text information is locally stored in the receiving terminal of the IM application device; and
displaying the text information and an animation corresponding to the icon of the animation corresponding to the text information in a chat window of a receiving terminal of the IM application device at the same time.

7. The information processing method according to claim 6, wherein, displaying an animation corresponding to the text information comprises: displaying the animation corresponding to the text information in full screen in the chat window.

8. An IM application device, which is a sending terminal in a communication system, comprising:
a first acquiring module which is used to acquire text information to be sent;
a sending module which is used to send the text information to a receiving terminal; and
a first display module which is used to display an animation corresponding to the text information in a chat window of a sending terminal of the IM application device, wherein a correspondence relationship between an icon of the animation and a keyword sentence taken as the text information is locally stored in the sending terminal of the IM application device.

9. The device according to claim 8, wherein, the first acquiring module is particularly used to receive the text information inputted through a man-machine interface module by a user.

10. The device according to claim 9, wherein,
the first acquiring module is particularly used to: acquire an icon of the animation corresponding to the text information taken as a keyword sentence according to the correspondence relationship between the icon of the animation and the keyword sentence, after acquiring the text information to be sent, before the first display module displays an animation corresponding to the text information;
the first display module is particularly used to display the animation corresponding to the icon of the animation corresponding to the text information.

11. The device according to claim 8, wherein, the first acquiring module is particularly used to: receive the icon of the animation selected by a user through a man-machine interface module; acquire a keyword sentence corresponding to the icon of the animation according to the correspondence relationship between the icon of the animation and the keyword sentence; and take the acquired keyword sentence as the text information to be sent.

12. The device according to claim 8, wherein, the first display module is particularly used to display the animation corresponding to the text information in full screen in a chat window.

13. An IM application device, which is a receiving terminal in a communication system, comprising:
a receiving module which is used to receive text information sent by a sending terminal;
a second acquiring module which is used to acquire an icon of an animation corresponding to the text information taken as a keyword sentence according to a correspondence relationship between the icon of the animation and the keyword sentence, wherein the correspondence relationship between the icon of the animation and the keyword sentence taken as the text information is locally stored in the receiving terminal of the IM application device; and
a second display module which is used to display the text information and an animation corresponding to the icon of the animation corresponding to the text information in a chat window of a receiving terminal of the IM application device at the same time.

14. The device according to claim 13, wherein, the second display module is particularly used to display the animation corresponding to the text information in full screen in a chat window.

15. A communication system, comprising an IM application device at the sending side and an IM application device at the receiving side which are in communication with each other; wherein, the IM application device at the sending side is an IM application device which is a sending terminal in a communication system, comprising:
a first acquiring module which is used to acquire text information to be sent;
a sending module which is used to send the text information to a receiving terminal; and
a first display module which is used to display an animation corresponding to the text information in a chat window of a sending terminal of the IM application device, wherein a correspondence relationship between an icon of the animation and a keyword sentence taken as the text information is locally stored in the sending terminal of the IM application device;
and the IM application device at the receiving side is an IM application device which is a receiving terminal in a communication system, comprising:
a receiving module which is used to receive text information sent by a sending terminal;
a second acquiring module which is used to acquire an icon of an animation corresponding to the text information taken as a keyword sentence according to a correspondence relationship between the icon of the animation and the keyword sentence, wherein the correspondence relationship between the icon of the animation and the keyword sentence taken as the text information is locally stored in the receiving terminal of the IM application device; and
a second display module which is used to display the text information and an animation corresponding to the icon of the animation corresponding to the text information in a chat window of a receiving terminal of the IM application device at the same time.

16. A terminal provided with an IM application device, wherein
the IM application device is at the sending side, and comprises:
a first acquiring module which is used to acquire text information to be sent;
a sending module which is used to send the text information to a receiving terminal; and
a first display module which is used to display an animation corresponding to the text information in a chat window of a sending terminal of the IM application device, wherein a correspondence relationship between an icon of the animation and a keyword sentence taken as the text information is locally stored in the sending terminal of the IM application device;
and/or
the IM application device is at the receiving side, and comprises:
a receiving module which is used to receive text information sent by a sending terminal;
a second acquiring module which is used to acquire an icon of an animation corresponding to the text information taken as a keyword sentence according to a correspondence relationship between the icon of the animation and the keyword sentence, wherein the correspondence relationship between the icon of the animation and the keyword sentence taken as the text information is locally stored in the receiving terminal of the IM application device; and
a second display module which is used to display the text information and an animation corresponding to the icon of the animation corresponding to the text information in a chat window of a receiving terminal of the IM application device at the same time.

17. A storage medium including computer-executable instructions which, when executed by the computer processor, are configured to perform an information processing method of IM application device comprising:
acquiring text information to be sent;
sending the text information to a receiving terminal; and
displaying an animation corresponding to the text information in a chat window of a sending terminal of the IM application device, wherein a correspondence relationship between an icon of the animation and a keyword sentence taken as the text information is locally stored in the sending terminal of the IM application device.

18. A storage medium including computer-executable instructions which, when executed by the computer processor, are configured to perform an information processing method of IM application device comprising:
receiving text information sent by a sending terminal;
acquiring an icon of an animation corresponding to the text information taken as a keyword sentence according to a correspondence relationship between the icon of the animation and the keyword sentence, wherein the correspondence relationship between the icon of the animation and the keyword sentence taken as the text information is locally stored in the receiving terminal of the IM application device; and
displaying the text information and an animation corresponding to the icon of the animation corresponding to the text information in a chat window of a receiving terminal of the IM application device at the same time.
